(19) United States
(12) Patent Application Publication
(10) Pub. No.: US 2003/0175665 A1
(43) Pub. Date: Sep. 18, 2003

(54) myChips - a mechanized, painless and maximized memorizer

(76) Inventor: Jian Zhang, Centreville, VA (US)

Correspondence Address: Jian Zhang, P.O. Box 1748, Centreville, VA, 20122, US

(21) Appl. No.: 10/099,393

(22) Filed: Mar. 18, 2002

(51) Int. Cl. G09B 19/00

(52) U.S. Cl. 434/236; 434/238

(57) ABSTRACT

myChips is a high efficient computational memory tool. It work by reducing rehearsal frequency to minimum while maintaining memory to maximum. Its underline algorithm is a function of its user's personal memory capability and rehearsal performance on a item. It is formulated as

g=f(p, r);

where p is a parameter reflecting user's personal memory capability, while r, a parameter reflecting user 's performance on the rehearsed item, and g, the time gap from one proposed schedule of rehearsal to another of rehearsal on the item.

myChips, therefore, is design to systematically prompt its user to rehearse only those things that are about to be forgotten. Its user interface design also makes myChips unique: grabbing user's attention, fitting in all kinds of people, training user to think faster, and making both boring and none-boring memorial processes mechanized and so on.

### CROSS REFERENCE TO RELATED APPLICATIONS

Not applicable.

### BACKGROUND

Memorizing things in school often means hard work: reading boring terms or formulas alike over and over again is not just time-consuming; trying hard to concentrate on something which is too boring to concentrate on is a pain. And, you often have something on the tip of your tongue even if you have seen or heard them lots of times recently. Memory needs a better solution.

Take a look at a way of physical exercising. Suppose you go to a gym for half an hour daily. You don't have any skill or knowledge on what and how. There is an experienced body trainer there, leading you and challenging you step-by-step, progress-by-progress. Once finished, you jog out away from the gym without looking back. The next day, you go there again regularly . . . .

If the brain could exercise that way, life would be much easier.

myChips is something that could assist you to make that happen. It is a computerized, high-efficient memory trainer. It guides you and challenges you step-by-step, progress-by-progress to build your memory power.

myChips achieves its highest efficiency by reducing rehearsal frequency to minimum while maintaining memory to maximum through an interactive, computational algorithm. The base of algorithm, drawn from its author's years of observation, experience and understanding, is that a correct recall can last memory longer than its previous one did. Or, put it this way: suppose you had remembered “1 mile=1.609 km” 5 days ago; you just now made rehearsal and recalled it correctly (i.e. you have not forgotten it); then, most likely you will also be able to recall it once again after another 5 days and longer. How much longer depends on your memory capability. myChips is so programmed that it automatically prompts you to recall only those things that are about to be forgotten. That way you could secure your memory to last longer while eliminating the effort and time for numerous less-efficient recalls.

The design of myChips also plays an important role. The IMPORT and EXPORT utilities allow its user to add new items into the myChips database easily and facilitate exchanges of “memory chips” among friends. That could eliminate the time spent on item collecting and typing. With MASK option, scoring system, REVIEW choice and the black screen background, myChips is designed to grab your attention, challenge your memory capability, and, if you choose, to train you to think faster. The SEARCH and EDIT features assist you in removing no longer wanted memories (things that you want to forget), correcting inaccurate memories and modifying and making links between memories as time goes on.

In addition to its maximized efficiency, the myChips-guided step-by-step mouse-click procedures make both boring and none boring memorial processes mechanized. Using it daily for a short while, you never need to think about it again throughout the rest of the day. It is like “plug it in, push the buttons and forget about it.”

myChips, allowing you to choose “skill” levels, attracting your full attention, scoring your operation and encouraging your speeding, is just like a game. You play the game once a day. And most importantly, you achieve your memorial goal as well.

myChips has several sister versions:

MyChips is a multi-user classroom version with a teacher making assignments and managing student accounts.

myChipS is a subject version, which automatically import items from an electronic textbook.

myChiPs is a pocket pc, or palm, version with a data transfer outlet to and from a desktop.

myChIps is an Internet application.

A complete web version of myChips, then called JESS MEMORY QUEEN, was coded in Perl on Unix in the summer of 2000 (FIGS. 10a-e in DRAWINGS), but soon it was recoded in Visual Basic (VB) to be used on PC, mostly because of the popularity of personal computers.

The CD-ROM enclosed in this application lists two of myChips versions: (1) myChips, a single-user personal version and (2) MyChips, a multi-user classroom version. Both of the versions are written in VB6 and used on PC with window 98 and higher. However, all versions above can be recoded with same functions in most of other languages and used on other platforms as well.

### SUMMARY

myChips is basically a human knowledge-developing machine. It collects knowledge and presents them to its user for rehearsal in both timely and selectively manners. The core of myChips is that it systematically prompts its user to rehearse only those things that are about to be forgotten, through an interactive, computational algorithm. Its user interface design also makes myChips unique: grabbing user's attention, fitting all kind of people, training user to think faster, and making both boring and none-boring memorial processes mechanized and so on.

### BRIEF DESCRIPTION OF DRAWINGS

FIG. 1a—Flowchart General, showing general data flow from one component to another.

FIG. 1b—Flowchart Specific, showing detailed data flow, the myChips' fundamental algorithm, inside BOX 2 in FIG. 1b.

FIG. 2a—Registration Page, allowing a user to pick username/password.

FIG. 2b—Secret Question/Answer Page, for.

FIG. 2c—Login Page, for access control.

FIG. 3—Home Menu.

FIG. 4a—Write Page, for inputting memorial items one-by-one.

FIG. 4b—File To Open Page, to access a batch file for importing.

FIG. 4c—Preview Batch File Page, before importing.

FIG. 5a—Rehearsal Mask Option, for choosing right or left mask.

FIG. 5b—Rehearsal Page 1: incomplete display for recall, the first 2 steps of rehearsal.

FIG. 5c—Rehearsal Page 2: complete display, the third step of rehearsal.

FIG. 5d—Rehearsal Page 3: mark correctness of recall, the last step of rehearsal.

FIG. 6a—Review Mask Option, for choosing right or left mask.

FIG. 6b—Review Page.

FIG. 7a—Monitor Page, showing progress in both numbers and graphics.

FIG. 7b—Memory Level Setting Page, showing dynamic recommendations and allowing its user to customize memory level.

FIG. 8—Search And Edit Page, for its user to query items and modify them.

FIG. 9a—Search And Collection Page, for exporting items from the database to a file.

FIG. 9b—Drive Access Page, for exporting items to a file.

FIGS. 10a-e—Interfaces of Perl Internet version and its sever.

### DETAILED DESCRIPTION

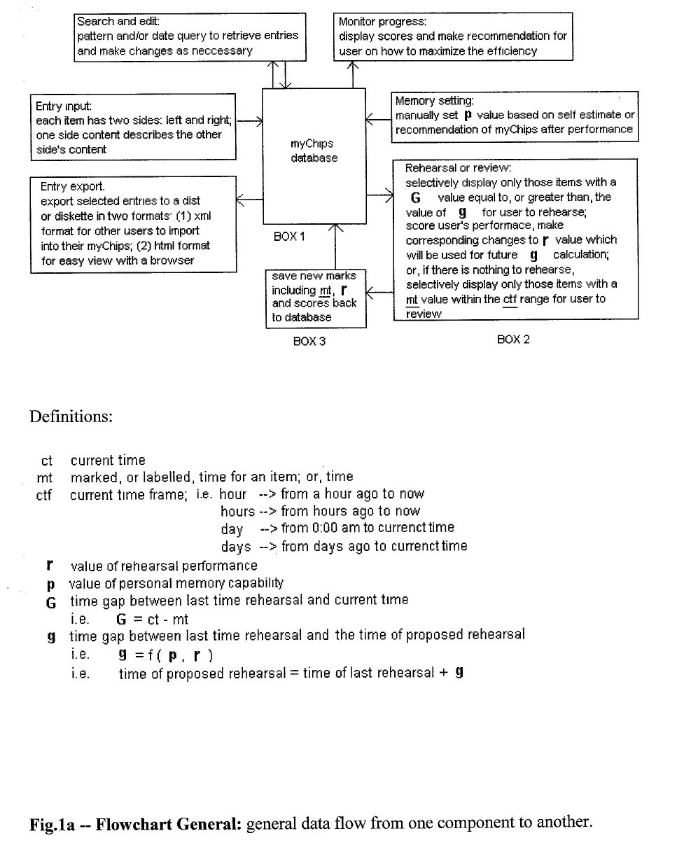

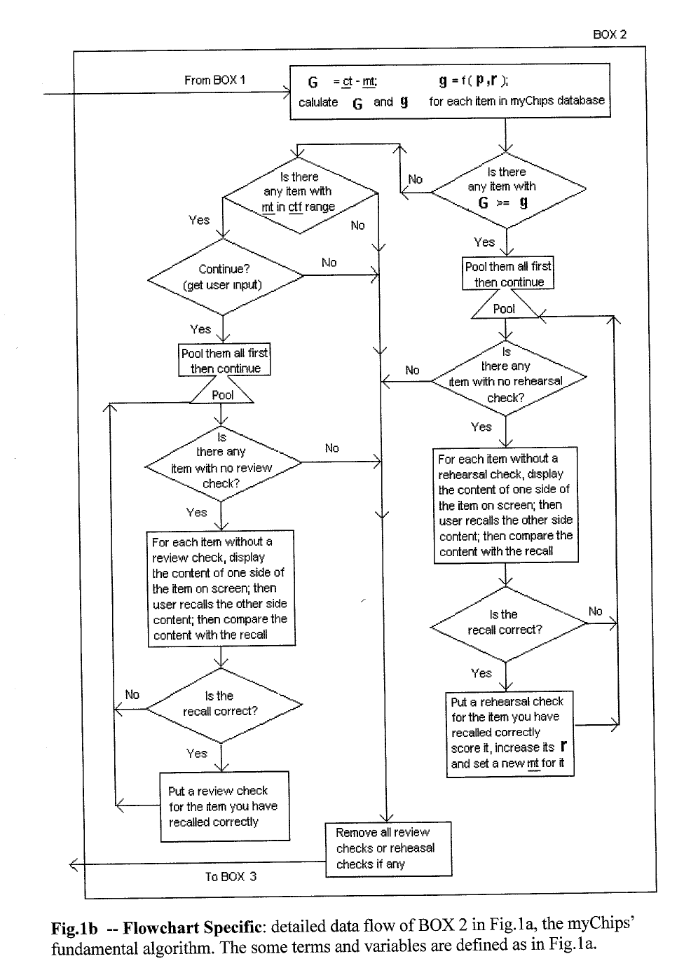

A general flowchart of myChips, described in FIG. 1a, showing general data flow from one component to another. A specific flowchart is in FIG. 1b, that describes details of myChips algorithm and shows detailed data flow.

But routinely, there are only two steps. (1) INPUT: type (or import) in new items to be memorized; (2) REHEARSE: recall myChips-presented items.

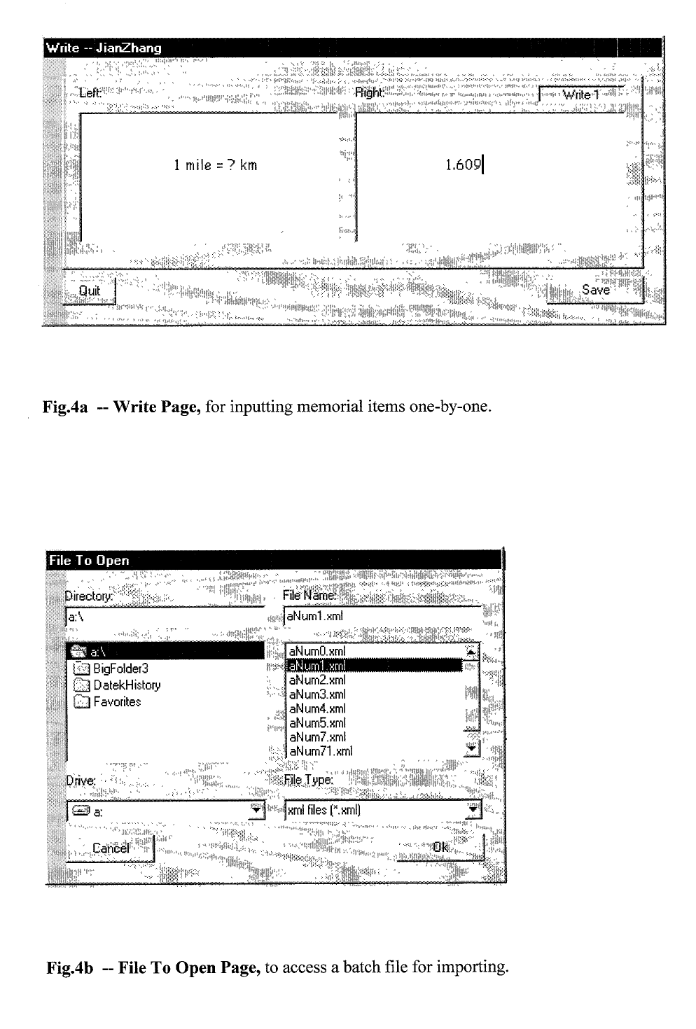

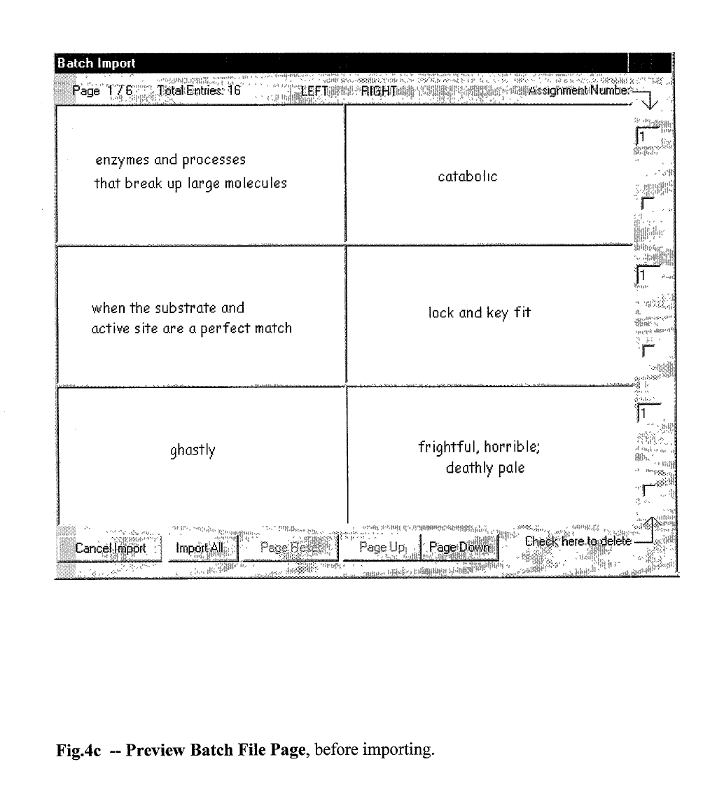

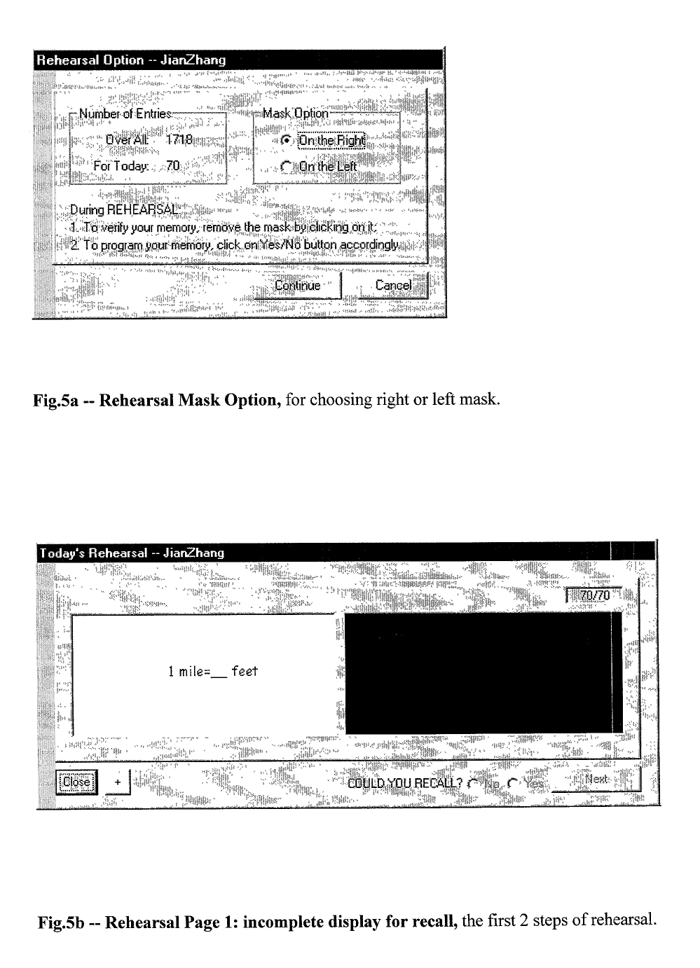

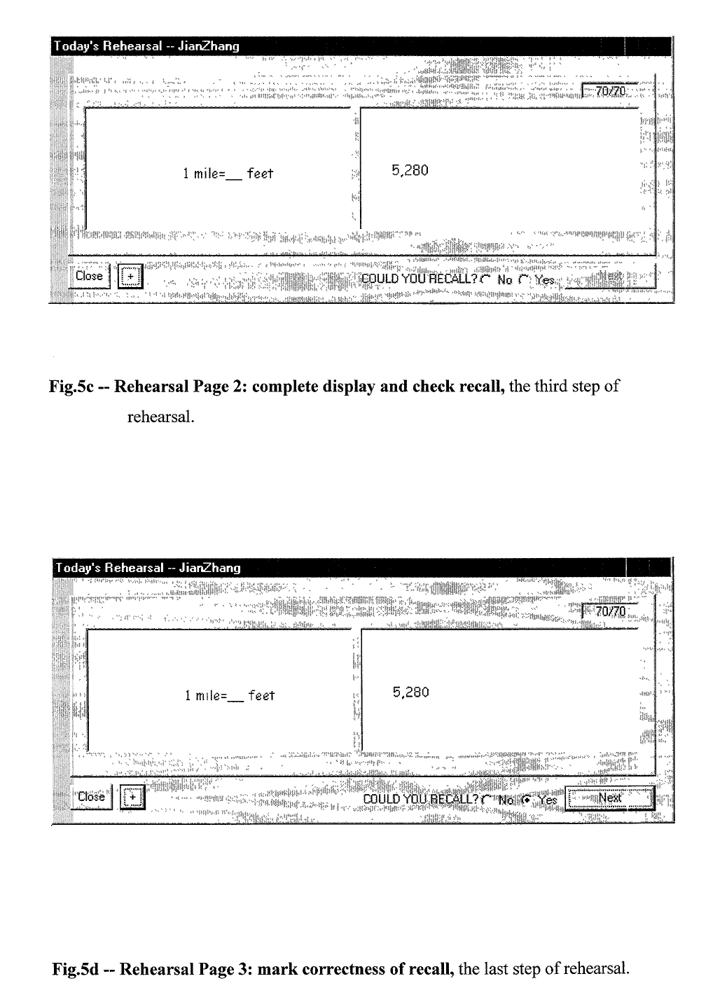

FIG. 4a shows myChips “Write” interface for its user to type in items one-by-one. myChips importing tool, whose interfaces are shown in FIG. 4b and FIG. 4c, can process a batch file if a disk with ready-to-import items is available from friends or a teacher. FIG. 4c is a preview page but one can edits its content as well. Each input item contains two parts: entry-left and entry-right. In order to serve memory purpose, the content of each item is separated into 2 parts: one part describes or defines the other. Or one part is an explicit or implicit question and the other is an explicit or implicit answer. Two text areas in the “Write” page (FIG. 4a) provide two separated spaces for each part of an item.

The item rehearsal process contains a sequential procedure: display one part-recall-display both part-mark. You do it all in a rehearsal window (FIGS. 5b-d). First, myChips selects an array of items (FIG. 5a) from its database based on its internal algorithm and presents them on screen one-by-one. For each item, it first displays only one part of the item and covers the other part to let you to recall it (FIG. 5b). You make a recall and then click on the mask, (FIGS. 5b-c), which will remove the mask and display the covered part. You then check your recall correctness and mark your recall by clicking on the yes/no radio button accordingly (FIGS. 5c-d). The display one part-recall-display both part-mark sequential procedure is enforced for each rehearsal. No skipping is allowed.

Mark your recall correctness is a crucial step for the user to interact with myChips. It records user's rehearsal performance on that item as a value (r), which will be used to determine the time for the next rehearsal for that item. The r value is stored in database and is set to 0 at the very beginning. Every time you rehearse, the r value for the rehearsed item increases or set back, depending on whether your answer is correct or wrong.

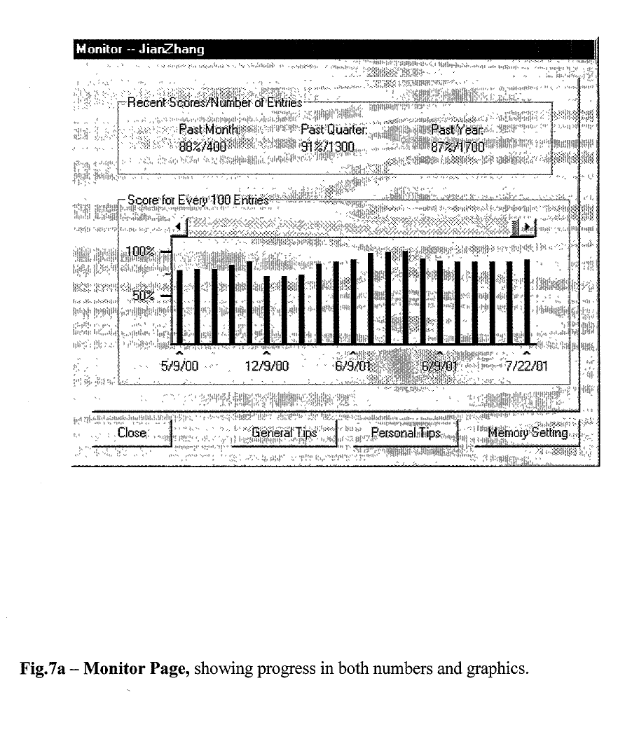

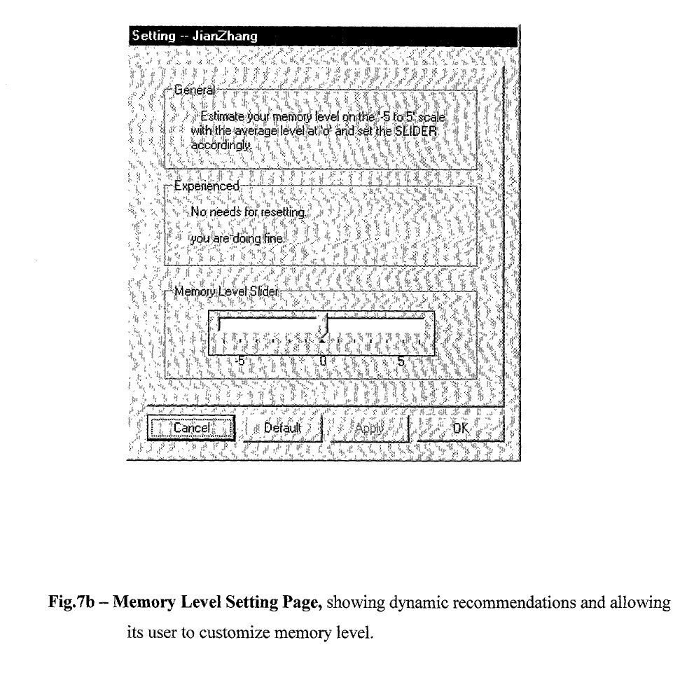

Of course, personal memory capability varies among people and affects memory efficiency. myChips provide a means (FIGS. 7a-b) to allow a user to customize personal memory level (p). Then use it together with the rehearsal performance value r to calculate the time gap (g) from one proposed rehearsal schedule to another for each individual item.

g=f(p,r);

The default p is an experimental value 0, reflecting a person with an average memory capability. A user can click on the “Monitor” button from the “Home” menu (FIG. 3) then “Memory Setting” button (FIG. 7a). Based on the displaying scale and dynamic instructions (FIG. 7b), adjust the setting accordingly.

The time estimated to spend on a daily workout depends largely on how many brand new items to be added each day to the memory database and how good your physical memory is. The following table (Table 1) is an example of a layout for an average person with 10 brand new items added into myChips database each day for illustration. The exactly formula used in this case is:

$$g = {( 1.7 + p )}^{r} or g = 2 if r < 2 ;$$

where

p=0;

r=0 at the very beginning for every item, increased by 1 every time you recall the item correctly, and set back to 0 if your recall is wrong, during its rehearsal.

TABLE 1
Estimate Time For Daily Rehearsal From 4 Sample Days

| | | | | Estimated |
|---|---|---|---|---|
| Samples of | New Chips | Total Chips | Chips myChips | Rehearsal |
| Work Day | Added daily | in Memory | Presented | Minutes |
| Day 1 | 10 | 10 | 10 | 5 |
| Day 10 | 10 | 100 | 50 | 15 |
| Day 100 | 10 | 1,000 | 80 | 25 |
| Day 1000 | 10 | 10,000 | 120 | 35 |

Note: (1) time to collect and input the 10 new items each day is excluded; (2) if you are not an average person, the time estimate might be different; (3) each item or entry is called a memory chip here;

There are two versions of myChips enclosed in the accompanying CD-ROM (1) myChips, a single-user personal version and (2) MyChips, a multi-user classroom version. Both of them use the same formula as in the above example. The single-user version is the basic model and I would like to use it as an example to show its specifications.

A. System requirement: Window 98 and higher on PC;

B. Installation: create a new folder in your PC, copy the myChips.exe file in either of the accompanying CD-ROMs into the newly created folder in your PC, and click on the myChips.exe icon in your PC folder to run.

C. Operation:

1. Register your account

1-1 myChips is username/password protected

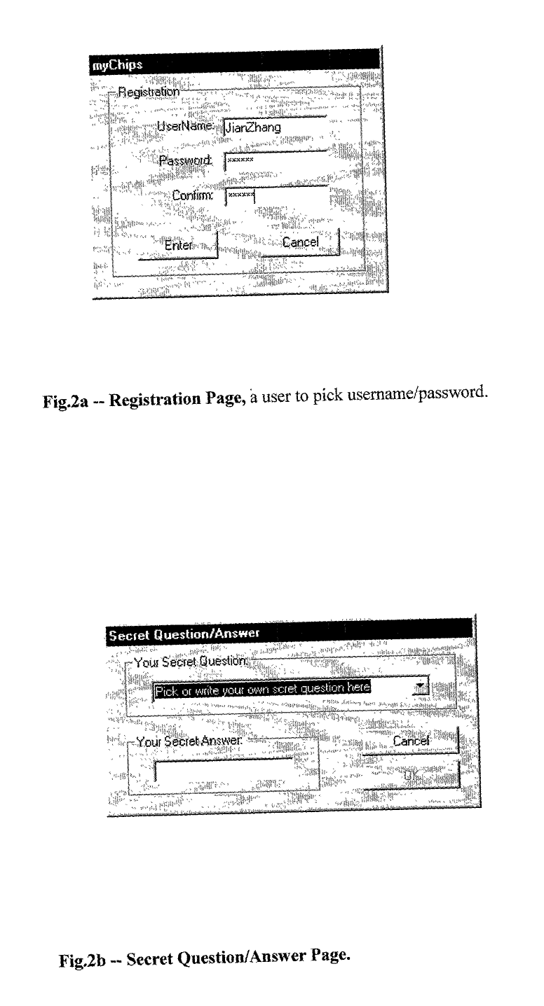

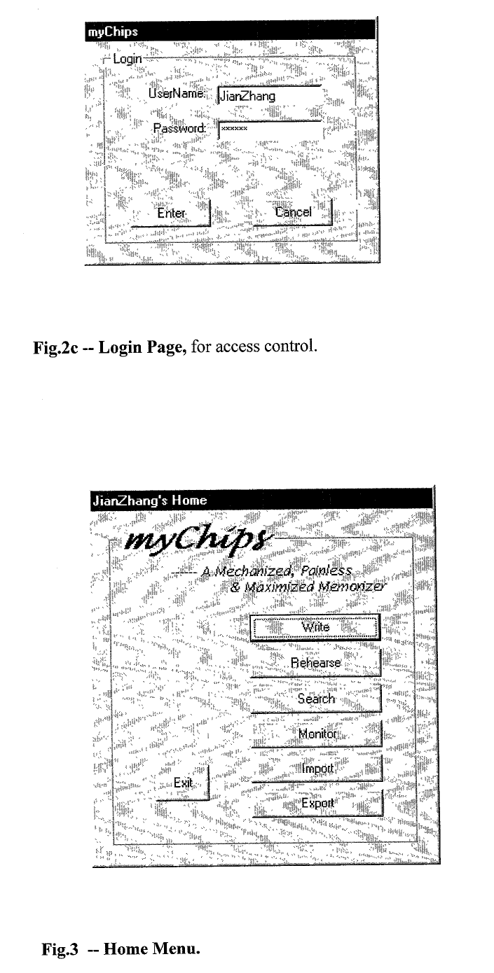

The first time you start myChips, you must pick your username/password for your database protection. Keep the password to yourself (FIG. 2a).

In case someday you lose your password, myChips asks you to set a secret question/answer pair when you register your account (FIG. 2b). At this point, you need to make sure the question you choose will not confuse even if quite a long time have passed.

1-2 Regain your access privilege after forgetting password

With the login window active, type in your username then double-click on the “Password:” label (FIG. 2c). You will be prompted to answer your secret question (FIG. 2b). If you answer is right, you will be given your lost password on the screen.

2. Input entries into your own myChips database

2-1 Write entries one by one

Click on “Write” button (FIG. 3), type in entries one-by-one (FIG. 4a).

2-2 Batch Import

Case 1. You may have a text file which contains many potential myChips entries. You could write those entries one by one through Write window mentioned in 2-1. However, you would hope you could edit the text file then import the whole file by a few mouse-clicks.

Case 2. You are reading web pages or some sort of electronic text. You did a lot of copying and pasting and hope it would produce a file, which could then be imported into myChips without tediously typing one entry after another.

Case 3. Your friends also have myChips. You hope all of you could mutually benefit if you could exchange myChips files.

myChips' IMPORT feature (FIG. 3, FIGS. 4b-c) is for all those purposes. In order to safely and smoothly accomplish that, four rules for the file format have to be followed:

(a) The first line of the file must start with

<myChips aNum=“d”>

where d is a number of any digits;

(b) Each entry-left must be embraced with <L> and </L>, and entry-right with <R> and </R> to form a block-left and a block-right;

(c) Block-left must start its own line(s) and block-right, too;

(d) The file ends with a line </myChips>.

It is always recommended that you view the entries once myChips prompts you to do optional preview (FIG. 4c). And you edit items if necessary.

3. Rehearse

3-1 Step-by-step standard rehearsal

Clicking on the “Rehearse” button from the menu (FIG. 3) leads you to a “Rehearsal Option” page (FIG. 5a) for a user to choose mask option. I you continue, an array of proposed rehearsal items are presented to you one-by-one by myChips (FIGS. 5b-d). There are 4 steps sequentially:

step 1: rehearsal entry partial display, FIG. 5b;

step 2: recall then fully display by clicking on the blocking mask (FIG. 5c);

step 3: check recall correctness;

step 4: clicking on the Yes/No radio button to mark recall (FIG. 5d).

3-2 Review

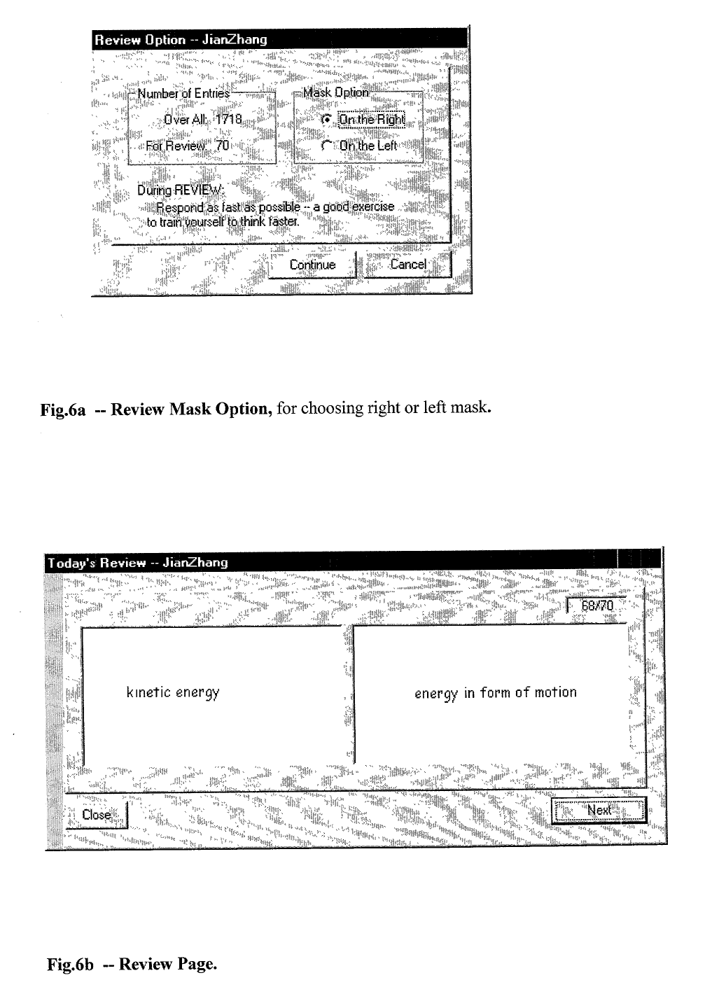

Once you have completed your rehearsal for the day, you do not have a second chance to do it again. But “Review” allows you to revisit the entries that have been rehearsed on that day. Click on the “Rehearse” button (FIG. 3) and follow instructions on display in Review Option Page (FIG. 6a). It will open a review page (FIG. 6b). “Review” can consolidate your memory and train your thinking to be faster. But note, “Review” is not available until you have completed “Rehearse” for the day.

4. Monitor and setting

4-1 Pre-set your memory level

It is a very good idea to pre-set your memory level by looking at a −5 to +5 scale and making an estimate for you.

Click on the “Monitor” button from the Home menu (FIG. 3) and then the “Memory Setting” button on FIG. 7a, you will see a scale pointing to the 0 position (FIG. 7b), which is default for an average person. Upgrade the setting if you are above the average, and downgrade, if below. Extremer goes to extreme.

4-2 Monitor progress

Once you have enough graded items in the database, the “Monitor” page will display your progress in numbers on the up panel and in graphic bars on the low panel (FIG. 7a). myChips makes recommendations and display them on the “Tips” pages (FIG. 7a). To monitor your progress and receive myChips recommendations, click on the “Monitor” button (FIG. 3) and then “Personal Tips” button (FIG. 7a).

4-3 Reset memory level

Based on your progress, myChips may make recommendations for you to re-set your memory level (FIG. 7b). To do so, click on the “Monitor” button on Home menu (FIG. 3) then the “Memory Setting” button of the “Monitor” page then set your memory level accordingly (FIG. 7b).

5. Search/View/Edit

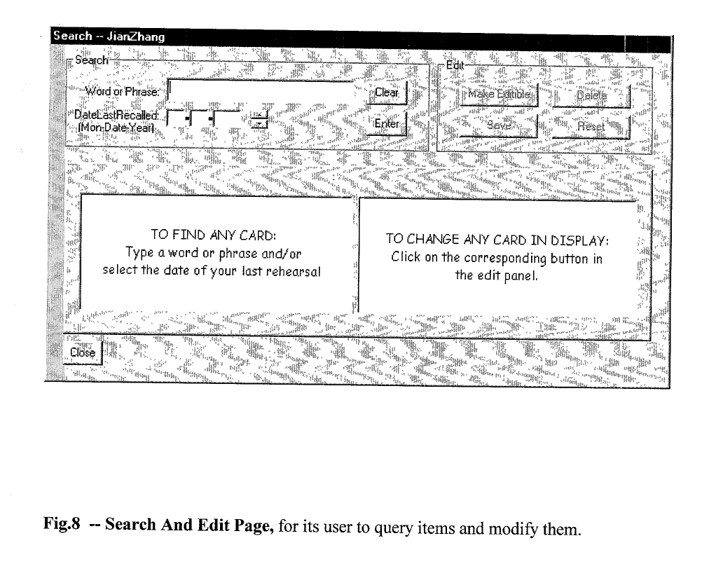

This component is your tool to access entries selectively through your database query. The query can be text patterns and/or the date of the entries you last rehearsed. You can then edit or even delete any entries if you want to. To use these features, click on “Search” button from menu (FIG. 3) and follow instructions (FIG. 8).

6. Exchange chips among friends

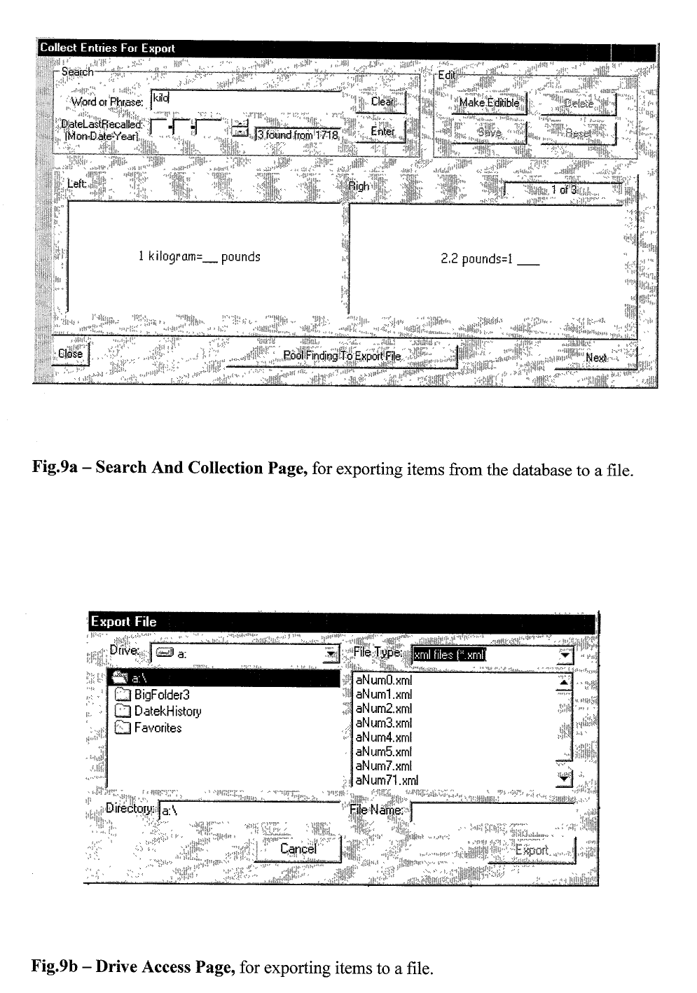

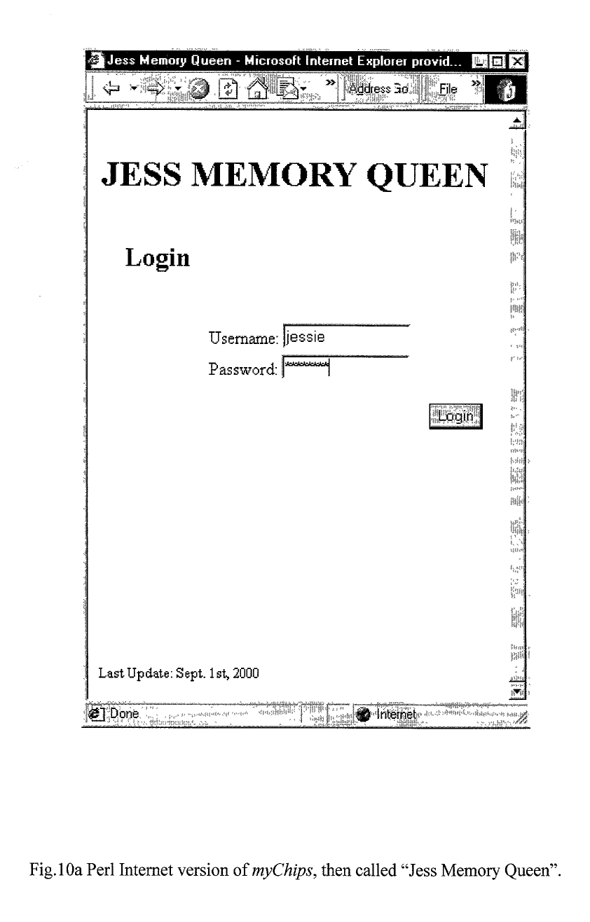

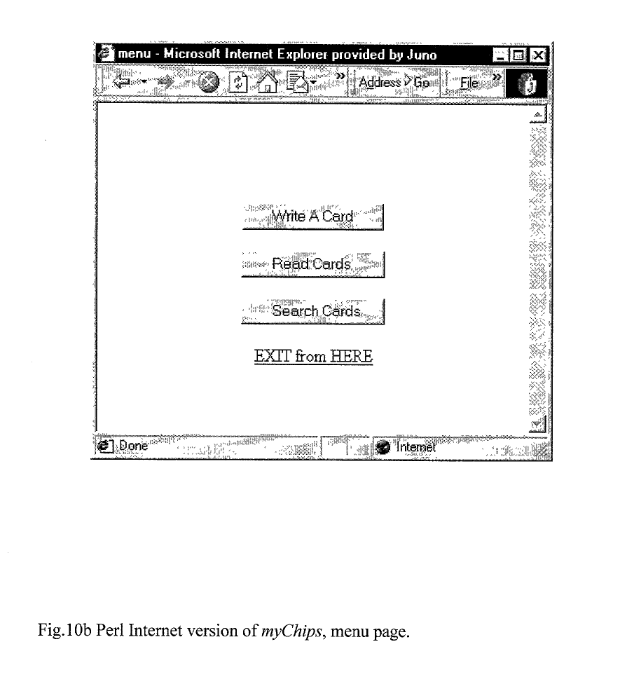

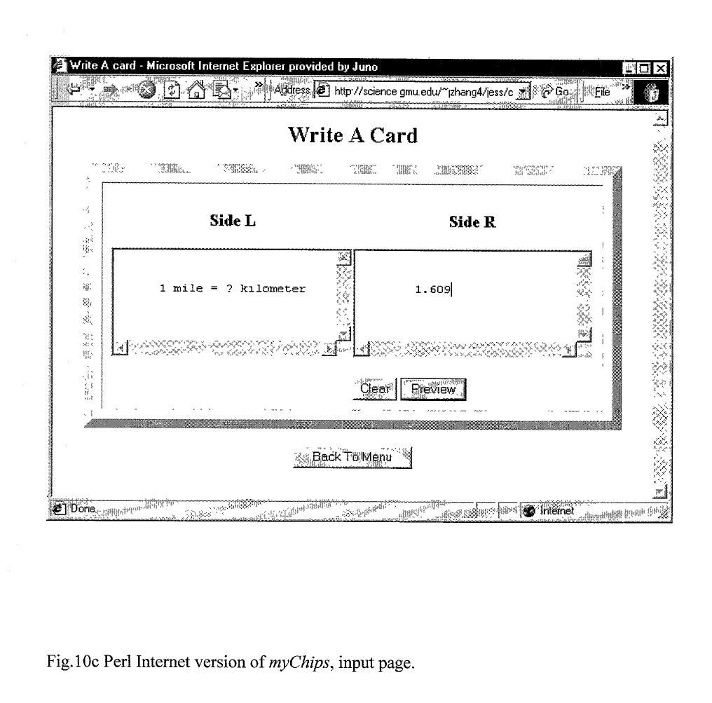

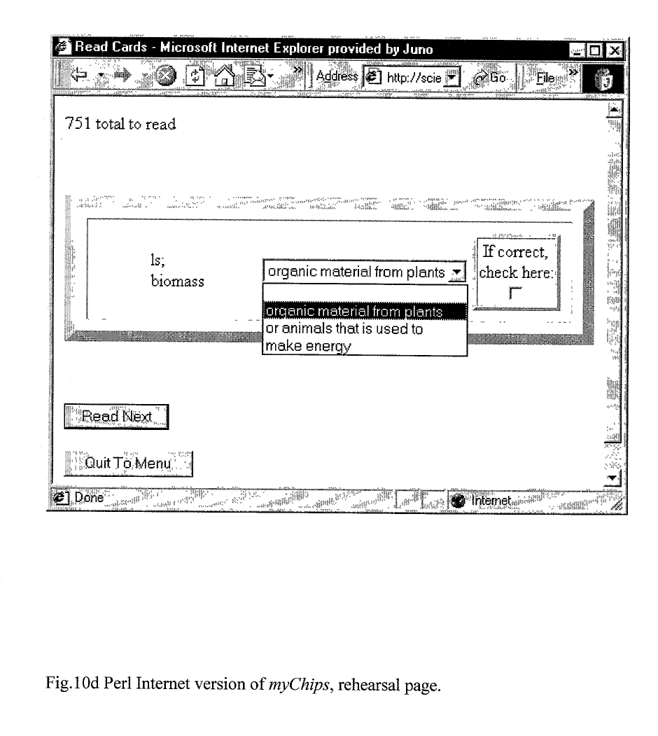

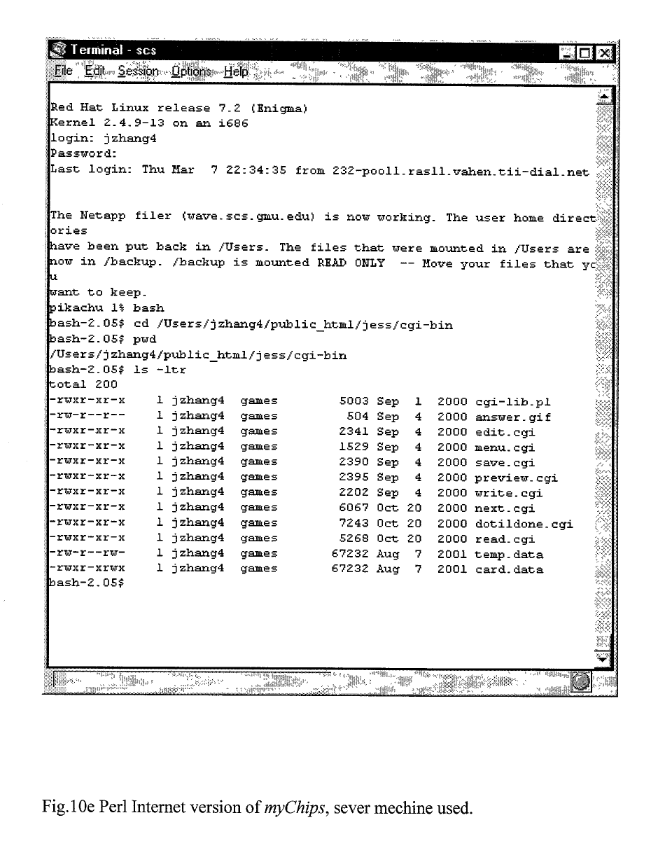

myChips has chips exchanging capability. Click on the “Export” button from menu (FIG. 3) and save the entries chosen from database into files in a disk or diskette (FIG. 9b), you can exchange chips with your friends.

Forming a study group and taking the advantage of Export/Import utilities, you can share chips among group members, and therefore, save time spent on entry collecting and typing.

I claim:

1. A machine of presenting rehearsal items selectively and timely, comprising:
(a) a storage holding memorial items;
(b) a means of establishing a value of a human operator's memory capability and storing said value in said storage;
(c) a means of recording rehearsal performance of said operator on each said item during rehearsal and storing said rehearsal performance as a value in said storage;
(d) retrieving and presenting any rehearsal item for said operator from said storage based largely on said values and the time gap since last rehearsal of said item.

2. A machine of presenting rehearsal items of claim 1 wherein retrieving and presenting any rehearsal item for said operator from said storage based largely on said value of memory capability of said operator raised to power said value of rehearsal performance of said operator on said item, and the time gap since last rehearsal of said item.

3. A machine of presenting rehearsal items of claim 1 wherein during rehearsal
(a) displaying only part content of said rehearsal item on screen to let said operator to recall the rest content of said rehearsal item;
(b) after said recall, displaying said rest content to allow said operator to check correctness of said recall;
(c) after said checking, providing a means to allow said correctness to be stored in said storage.
